(19) United States
(12) Patent Application Publication
(10) Pub. No.: US 2022/0197716 A1
(43) Pub. Date: Jun. 23, 2022

(54) SECURITY REQUIREMENT-BASED WORKLOAD MIGRATION

(71) Applicant: VMWARE, INC., Palo Alto, CA (US)

(72) Inventors: SHIRISH VIJAYVARGIYA, Pune (IN); SUNIL HASBE, Pune (IN); SACHIN SHINDE, Pune (IN)

(21) Appl. No.: 17/174,381

(22) Filed: Feb. 12, 2021

(30) Foreign Application Priority Data
Dec. 21, 2020 (IN) 202041055572

(51) Int. Cl. G06F 9/50; G06F 9/455; H04L 29/06

(52) U.S. Cl. CPC G06F 9/5088; G06F 9/505; G06F 9/45558; G06F 2009/4557; H04L 63/1416; H04L 63/20; G06F 2009/45591; H04L 63/1425

(57) ABSTRACT

In an example, a behavioural characteristic of a workload running on a first host computing device in a data center may be monitored. Further, a security requirement of the workload may be determined based on the behavioural characteristic of the workload. Furthermore, a second host computing device that supports the security requirement of the workload may be determined. Further, a recommendation may be generated to migrate the workload running on the first host computing device to the second host computing device in the data center.

### RELATED APPLICATIONS

Benefit is claimed under 35 U.S.C. 119(a)-(d) to Foreign Application Serial No. 202041055572 filed in India entitled “SECURITY REQUIREMENT-BASED WORKLOAD MIGRATION”, on Dec. 21, 2020, by VMware, Inc., which is herein incorporated in its entirety by reference for all purposes.

### TECHNICAL FIELD

The present disclosure relates to data centers, and more particularly to methods, techniques, and systems for migration of workloads in a data center based on security requirements of the workloads.

### BACKGROUND

A cloud computing system refers to a collection of computing devices on which data can be remotely stored and accessed. For example, cloud computing infrastructures often include a collection of physical servers organized in a hierarchical structure including computing zones, clusters, virtual local area networks (VLANs), racks, fault domains, and the like, referred to as a data center. Cloud computing systems often make use of different types of virtual services or workloads (e.g., computing containers, virtual machines (VMs), and the like) that provide remote storage and computing functionality to various clients or customers. These workloads can be hosted by respective physical servers (e.g., host computing devices) on a cloud computing system. Further, various security solutions are deployed to provide security to such workloads in the data center.

### BRIEF DESCRIPTION OF THE DRAWINGS

FIG. 1 is a block diagram of an example host computing device, including a context module to provide a recommendation to migrate an application host running on the host computing device to another host computing device in a data center based on a security requirement;

FIG. 2 is a block diagram of an example management node, including a management application to determine whether to migrate a workload from a first host computing device to a second host computing device in a data center based on a security requirement;

FIG. 3 is a flowchart illustrating an example method for generating a recommendation to migrate a workload running on a first host computing device to a second host computing device in a data center based on a security requirement;

FIG. 4 is a flowchart illustrating an example method for generating a recommendation to configure a host computing device with a security solution that supports a security requirement of a workload;

FIG. 5 is a flowchart illustrating an example method for determining migration of a workload from a first host computing device to a second host computing device in a data center based on a security requirement; and

FIG. 6 is a block diagram of an example host computing device including non-transitory machine-readable storage medium storing instructions to provide a recommendation to migrate a workload running on a first host computing device to a second host computing device based on a security requirement of the workload.

The drawings described herein are for illustration purposes only and are not intended to limit the scope of the present subject matter in any way.

### DETAILED DESCRIPTION

The term “virtual computing instance (VCI)” may cover a range of computing functionality. VCIs may include non-virtualized physical hosts, virtual machines (VMs), and/or containers. Containers can run on a host operating system without a hypervisor or separate operating system, such as a container that runs within Linux. A container can be provided by a VM that includes a container virtualization layer (e.g., Docker). A VM refers generally to an isolated user space instance, which can be executed within a virtualized environment. Other technologies aside from hardware virtualization can provide isolated user space instances, also referred to as VCIs. The term “VCI” covers these examples and combinations of different types of VCIs, among others.

The VMs, in some examples, may operate with their own guest operating systems on a host computing device using resources of the host virtualized by virtualization software (e.g., a hypervisor, VM monitor, and the like). The tenant (i.e., the owner of the VM) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VM segregation that may be offered in hypervisor-virtualized environments that virtualize system hardware, and thus can be viewed as a form of virtualization to isolate different groups of applications that operate in different containers.

Multiple VCIs can be configured to be in communication with each other in a distributed computing system (e.g., a data center). Thus, the virtual computing environment may include a number of data centers (e.g., software defined data centers (SDDCs)), with each SDDC including multiple hosts (i.e., physical host computing devices) executing workloads (e.g., VMs, containers, and the like) running therein.

Further, various security solutions may be deployed in the host computing devices, for instance, by a security administrator to provide security to the workloads at various levels. Example security solutions may include, but not limited to:
Intrusion Prevention System (IPS): The IPS may provide a deep packet and anomaly inspection to protect the workloads against both common and complex embedded attacks.
Endpoint Security Solution: In the virtualized environment (e.g., with VMWare® vShield product), an endpoint security appliance may be installed as a separate VM appliance. The endpoint security product may protect the VM by providing security via scanning VM input/output activities.
Micro-Segmentation Solution: Micro-segmentation may use a network virtualization technology to create increasingly granular secure zones in the data centers and cloud deployments, which isolate each individual workload and secure each workload separately. For example, a network virtualization platform (e.g., VMWare® NSX) may inspect east-west traffic and protect the workloads by containing spread of vulnerabilities across the east-west network.
Edge Security Solution: The edge security solution may analyse north-south traffic and provide security to the workloads.
Firewall solution: Various types of firewalls such as an application firewall, an edge firewall, a context firewall, and the like may protect the workloads against both common and complex embedded attacks.
Disaster Recovery: Critical VMs may be protected and migrated to a disaster recovery site in case of disaster or widespread of malicious activity in the data center. In such scenarios, a separate network link or replication link may need to be setup with the disaster recovery site.
Identify and access management solution: This solution may prevent un-authorized accesses to malicious users.

In such virtualized environments, a security administrator may have to deploy multiple security solutions on the host computing devices as each host computing device can run different workloads deployed thereon. Thus, in the virtualized environments, a security infrastructure is setup by the security administrator. However, the workloads (e.g., VMs, containers, applications, and the like) are deployed by a system administrator (e.g., VMWare® vSphere administrator). In such scenarios, the system administrator may deploy a workload to a different host computing device due to various reasons. For example, the workload may be deployed in a different host computing device because of an administrator error. In another example, activities of the workloads may not be predictable prior to deploying the workloads

Furthermore, each workload may have different characteristics and hence may require a different security solution. For example, a finance multi-tiered application may require communication between various services such as databases running on different containers or VMs. This type of application may require micro-segmentation type of service. Similarly, not all host computing devices and the corresponding workloads may need to have disaster recovery capability as only critical workloads may need to be protected with the disaster recovery. Thus, a subset of host computing devices should be configured with dedicated replication link. Thus, multi-layer data center protection deployment without knowing application/workload characteristics may include following overheads:
Deployment overhead: Deployment of the security solutions on multiple host computing devices may require purchasing multiple licenses of the security solutions, which may increase the cost.
Maintenance overhead: Upgrading the security solution on the host computing devices may consume a significant amount of time.
Performance overhead: Too much protection can be worse than no protection as workload activities may be monitored/scanned by multiple security solutions, which can affect the performance of the workload.

Examples described herein may provide dynamic placement (i.e., VMware® vMotion/migration) of the workloads on appropriate host computing devices based on workload characteristics and the security solutions deployed in the host computing devices. In one example, a behavioural characteristic of a workload (e.g., a VM, container, application, or the like) running on a first host computing device in a data center may be monitored. Further, a security requirement of the workload may be determined based on the behavioural characteristic of the workload. Furthermore, a second host computing device that supports the security requirement of the workload may be determined. Then, a recommendation may be generated to migrate the workload running on the first host computing device to the second host computing device in the data center.

In another example, when the second host computing device that supports the security requirement is not available in the data center, a recommendation may be generated to configure the first host computing device with the security solution that supports the security requirement of the workload.

Thus, examples described herein may provide an approach to migrate the workloads as per their security characteristics to appropriate host computing devices that are selectively configured with a required security solution. By selectively configuring the host computing devices with the required security solutions:
a load on the security solutions can be reduced and hence the security solution can be made scalable.
performance of the workloads may be enhanced as each workload activity may not be scanned by multiple irrelevant security solutions.
licensing cost and administration overhead may be reduced.
security of the workloads can be enhanced as each security solution can tune for deep packet level inspection to provide significantly high security.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

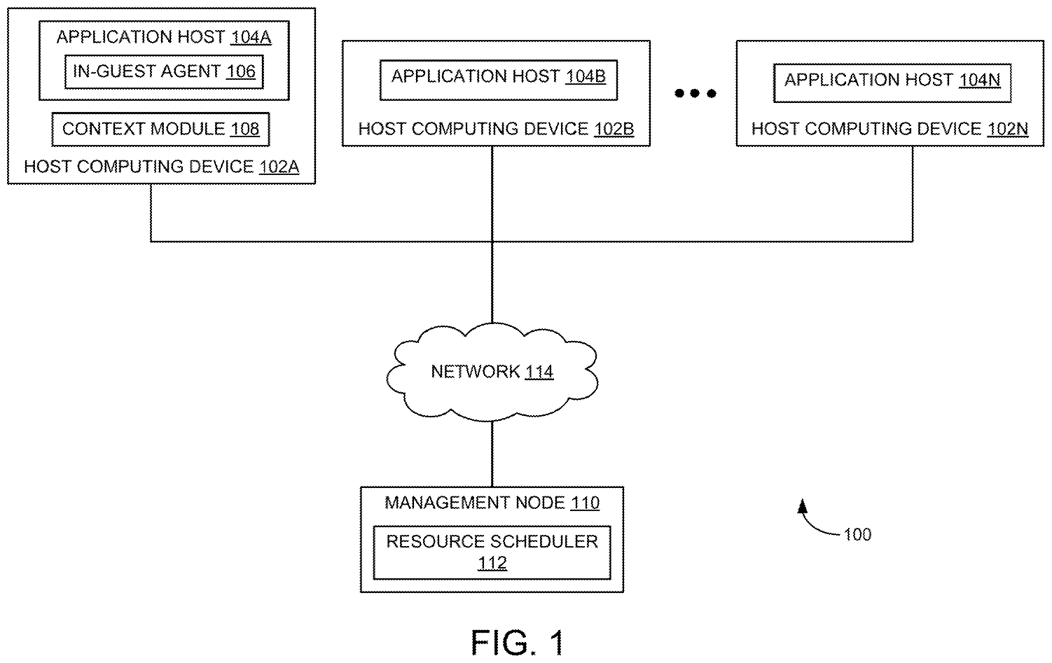

Turning now to the figures, FIG. 1 is a block diagram of an example host computing device 102A, including a context module 108 to provide a recommendation to migrate an application host 104A running on host computing device 102A to another host computing device (e.g., 102B or 102N) in a data center 100 based on a security requirement. Example data center or system 100 may be a pool or collection of cloud infrastructure resources designed for enterprise needs. Further, data center 100 may be a virtual representation of a physical data center, complete with servers, storage clusters, and networking components, all of which may reside in virtual space being hosted by one or more physical data centers.

As shown in FIG. 1, data center 100 may include multiple host computing devices 102A-102N. For example, a host computing device may be a physical computer executing different application hosts (e.g., 104A-104N) such as VMs, containers, and/or the like. The physical computer may be a hardware-based device (e.g., a personal computer) including an operating system (OS) and executing the application hosts and/or applications. A VM may operate with its own guest OS on the physical computer using resources of the physical computer virtualized by virtualization software (e.g., a hypervisor, a virtual machine monitor, and the like). A container may be a data computer node that runs on top of a host OS without the need for a hypervisor or separate OS. In some examples, each host computing device may run a hypervisor that creates and runs VMs.

Further, data center 100 may include a management node 110 assigned to one or more host computing devices 102A-102N. Example management node 110 may execute centralized management services that may be interconnected to manage corresponding host computing devices 102A-102N centrally in the virtualized cloud computing infrastructure. Example centralized management service may be a part of vCenter Server™ and vSphere® program products, which are commercially available from VMware®.

Furthermore, host computing devices 102A-102N and management node 110 may be communicatively coupled via a network 114. Example network 114 can be a managed Internet protocol (IP) network administered by a service provider. For example, network 114 may be implemented using wireless protocols and technologies, such as Wi-Fi, WiMax, and the like. In other examples, network 114 can also be a packet-switched network such as a local area network, wide area network, metropolitan area network, Internet network, or other similar type of network environment. In yet other examples, network 114 may be a fixed wireless network, a wireless local area network (LAN), a wireless wide area network (WAN), a personal area network (PAN), a virtual private network (VPN), intranet or other suitable network system and includes equipment for receiving and transmitting signals.

As shown in FIG. 1, host computing devices 102A-102N may include corresponding application hosts 104A-104N. Further, application hosts 104A-104N may execute corresponding applications. Example application host may include a VM, a container, or the like. Further as shown in FIG. 1, application host 104A may include an in-guest agent 106. During operation, in-guest agent 106 may identify a behavioural characteristic of an application running in application host 104A.

In an example, in-guest agent 106 can be a part of application host 104A (e.g., a VM) itself or may run inside a secure enclave created in application host 104A using a hypervisor-based enclave technology such as Guest Mode Monitoring (GMM) or Hardware Trusted Execution Environment (TEE) technologies like Software Guard Extensions (SGX). For example, the GMM “secure enclave of a VM” may be a region of memory in the VM's guest memory address space that is isolated from, and thus inaccessible by, all other processes running in the VM (e.g., including privileged processes like the VM's guest Operating System (OS) kernel). Thus, code running in the GMM may not be compromised via attacks within the VM, including attacks that target the guest OS.

Further, host computing device 102A may include context module 108. In an example, context module 108 may run inside host computing device 102A (e.g., enterprise-class, type-1 hypervisor (VMware ESXi)) as a host daemon or context module 108 can be run as separate appliance running on host computing device 102A. During example operation, context module 108 may determine a security requirement of the application based on the identified behavioural characteristic of the application. In an example, context module 108 may capture inbound and/or outbound network flow associated with application host 104A running on host computing device 102A. Further, context module 108 may measure network traffic of application host 104A running on host computing device 102A based in the inbound and/or outbound network flow. Furthermore, context module 108 may identify the behavioural characteristic of the application based on the measured network traffic.

In another example, context module 108 may monitor an input/output (I/O) activity performed by application host 104A. Further, context module 108 may identify the behavioural characteristic of the application based on the monitored I/O activity. In yet another example, context module 108 may determine whether application host 104A requires disaster recovery protection from a protection site to a recovery site based on a type of the application. Further, context module 108 may identify the behavioural characteristic of the application based on the determination that application host 104A requires disaster recovery protection.

Further, context module 108 may provide a recommendation, to management node 110, to migrate the application or application host 104A to another host computing device (e.g., 102B or 102N) that supports the security requirement of the application. In an example, context module 108 may obtain security policy information of data center 100 from management node 110. Example security policy information may include mapping between a plurality of host computing devices 102A-102N and corresponding security solutions. Further, context module 108 may compare the behavioural characteristic of the application with the security policy information of data center 100. Furthermore, context module 108 may provide the recommendation to migrate the application or application host 104A based on the comparison.

As shown in FIG. 1, management node 110 may include a resource scheduler 112 to determine a second host computing device (e.g., 102B or 102N) that supports the security requirement of the application. Further, management node 110 may migrate the application or application host 104A to the second host computing device (e.g., 102B or 102N) in accordance with the recommendation. The term “migration” may refer to migration of an application host (e.g., 104A-104N) from one physical host computing device to another host computing device. An example for migration activity may be VMware® VMotion™. VMotion is a technology to enable application host 104A to be moved from one host computing device to another, while application host 104A is running and with no interruption in service. This technology may be referred to as “live migration”. In other examples, migrating the application may include restarting the application on another host computing device.

In some examples, the functionalities described in FIG. 1, in relation to instructions to implement functions of in-guest agent 106, context module 108, resource scheduler 112, and any additional instructions described herein in relation to the storage medium, may be implemented as engines or modules including any combination of hardware and programming to implement the functionalities of the modules or engines described herein. The functions of in-guest agent 106, context module 108, and resource scheduler 112 may also be implemented by a respective processor. In examples described herein, the processor may include, for example, one processor or multiple processors included in a single device or distributed across multiple devices. Further, examples described herein may be implemented in products such as VMWare® AppDefense, which can enhance the security of application hosts within a host computing device.

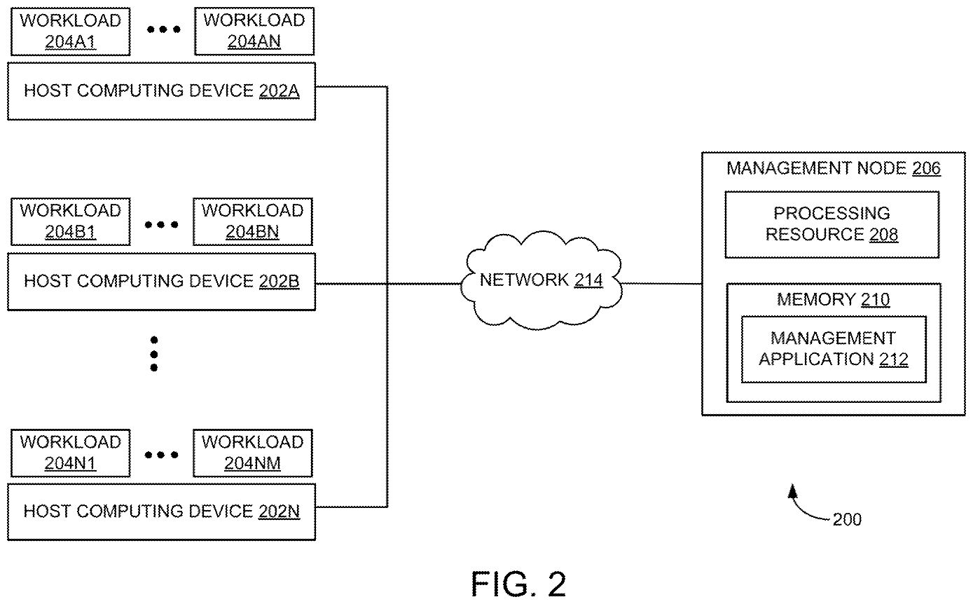

FIG. 2 is a block diagram of an example management node 206, including a management application 212 to determine whether to migrate a workload 204A1 from a first host computing device 202A to a second host computing device 202B or 202N in a data center 200 based on a security requirement. Example data center 200 may include multiple host computing devices 202A-202N executing multiple workloads (e.g., 204A1-204AN, 204B1-204BN, and 204N1-204NM). For example, host computing device 202A may execute workloads 204A1-204AN, host computing device 202B may execute workloads 204B1-204BN, and host computing device 202N may execute workloads 204N1-204NM. Example workload can be a VM, a container, an application, or the like.

Further, data center 200 may include management node 206, which may be assigned to host computing devices 202A-202N to execute centralized management services. Furthermore, host computing devices 202A-202N may be in communication with management node 206 via a network 214. In an example, management node 206 may include a processing resource 208 and a memory 210 having management application 212 executable by processing resource 208.

During operation, management application 212 may obtain a security requirement of workload 204A1 running on first host computing device 202A in data center 200. In an example, first host computing device 202A may determine the security requirement of workload 204A1. For example, first host computing device 202A may identify a characteristic of workload 204A1 based on a parameter selected from a group consisting of network flow information, input/output (I/O) activity information, and disaster recovery protection requirement. Further, first host computing device 202A may determine the security requirement of workload 204A1 based on the behavioural characteristic of workload 204A1.

Further, management application 212 may determine whether second host computing device (e.g., 202B) that supports the security requirement of workload 204A1 is available in data center 200. In an example, management application 212 may determine whether second host computing device 202B having a license for the security solution that supports the security requirement of workload 204A1 is available in data center 200.

In one example, management application 212 may configure first host computing device 202A with the security solution that supports the security requirement of workload 204A1 when second host computing device 202B that supports the security requirement is not available in data center 200.

In another example, management application 212 may migrate workload 204A1 running on first host computing device 202A to second host computing device 202B that supports the security requirement of the application when second host computing device 202B that supports the security requirement is available in data center 200.

In some examples, the functionalities described in FIG. 2, in relation to instructions to implement functions of management application 212 and any additional instructions described herein in relation to the storage medium, may be implemented as engines or modules including any combination of hardware and programming to implement the functionalities of the modules or engines described herein. The functions of management application 212 may also be implemented by a respective processor. In examples described herein, the processor may include, for example, one processor or multiple processors included in a single device or distributed across multiple devices.

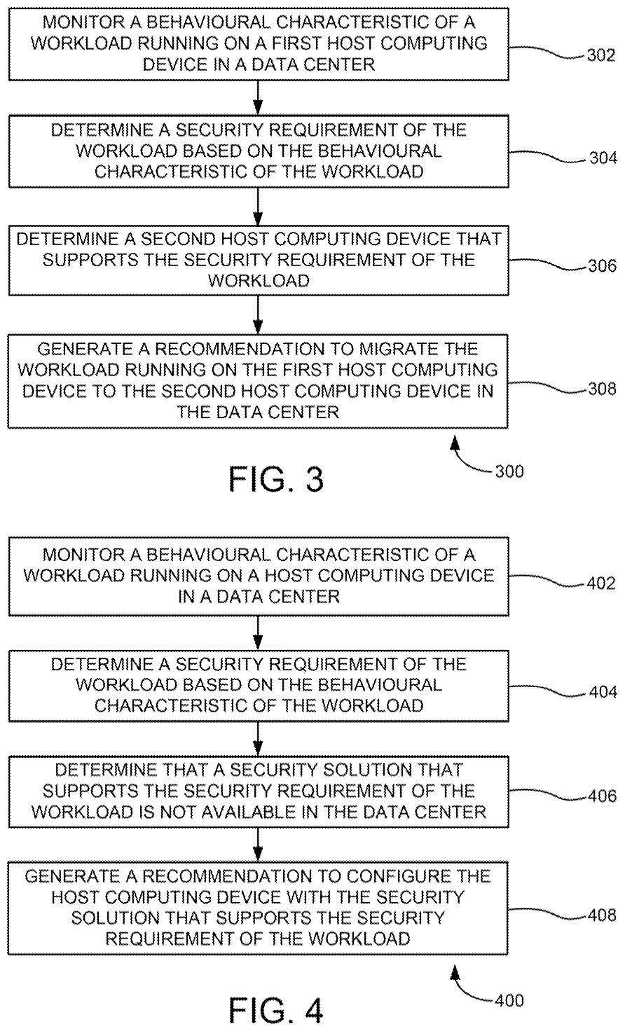

FIG. 3 is a flowchart illustrating an example method 300 for generating a recommendation to migrate a workload running on a first host computing device to a second host computing device in a data center based on a security requirement. It should be understood that the process depicted in FIG. 3 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 302, a behavioural characteristic of a workload running on a first host computing device in a data center may be monitored. Example workload may include an application, a VM, a container, or a like. In an example, the characteristic of the workload may be monitored based on a parameter selected from a group consisting of network flow information, input/output (I/O) activity information, and disaster recovery protection requirement. Example network flow information may include inbound and outbound network flow that can be utilized to understand network topology and to generate a network flow corresponding to the workload. Further, the network flow information may enable to understand whether communication is happening over private internet protocol (IP) or public IP.

At 304, a security requirement of the workload may be determined based on the behavioural characteristic of the workload. At 306, a second host computing device that supports the security requirement of the workload may be determined. In an example, determining the second host computing device that supports the security requirement of the workload may include determining the second host computing device having a license for a security solution that supports the security requirement of the workload.

At 308, a recommendation may be generated to migrate the workload running on the first host computing device to the second host computing device in the data center. For example, a recommendation may be generated to move a network communication centric container or VM to a host computing device where a micro-segmentation solution is deployed if inter VM/container communication is happening. In another example, for public IP communication, a recommendation may be generated to move the network centric VM/container to a host computing device which is configured to use an edge firewall. In yet another example, for a disaster recovery site communication/replication, a recommendation may be generated to move the VM/container to a host computing device which has a dedicated link with a disaster recovery site. In yet another example, based on the IO activities, a recommendation may be generated to move the IO centric container or VM to a host computing device where an endpoint security solution is deployed.

Further, example method 300 may include migrating the workload running on the first host computing device to the second host computing device in accordance with the recommendation.

FIG. 4 is a flowchart illustrating an example method 400 for generating a recommendation to configure a host computing device with a security solution that supports a security requirement of a workload. It should be understood that the process depicted in FIG. 4 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 402, a behavioural characteristic of a workload running on a host computing device in a data center may be monitored. In an example, monitoring the behavioural characteristic of the workload may include:
capturing inbound and/or outbound network flow associated with the workload running on the host computing device,
measuring network traffic of the workload running on the host computing device based on the inbound and/or outbound network flow, and
identifying the behavioural characteristic of the workload based on the measured network traffic.

In another example, monitoring the behavioural characteristic of the workload may include:
monitoring an input/output (I/O) activity performed by the workload, and
identifying the behavioural characteristic of the workload based on the monitored I/O activity.

In yet another example, monitoring the behavioural characteristic of the workload may include:
determining a type of an application running on the workload,
determining whether the workload requires disaster recovery protection from a protection site to a recovery site based on the type of application, and
identifying the behavioural characteristic of the workload based on the determination that the workload requires the disaster recovery protection.

At 404, a security requirement of the workload may be determined based on the behavioural characteristic of the workload. At 406, a check may be made to determine that a security solution that supports the security requirement of the workload is not available in the data center. In an example, determining that the security solution that supports the security requirement of the workload is not available may include:
comparing the security requirement of the workload with security policy information of the data center. In an example, the security policy information may include mapping between a plurality of host computing devices and corresponding security solutions.
determining that the security solution that supports the security requirement of the workload is not available in the data center based on an outcome of the comparison (i.e., when the security requirement of the workload does not match with any of the security solutions in the data center).

At 408, a recommendation may be generated to configure the host computing device with the security solution that supports the security requirement of the workload. Further, example method 400 may include configuring the host computing device with the security solution that provides the security requirement in accordance with the recommendation. In this example, the security solution may be deployed in the host computing device.

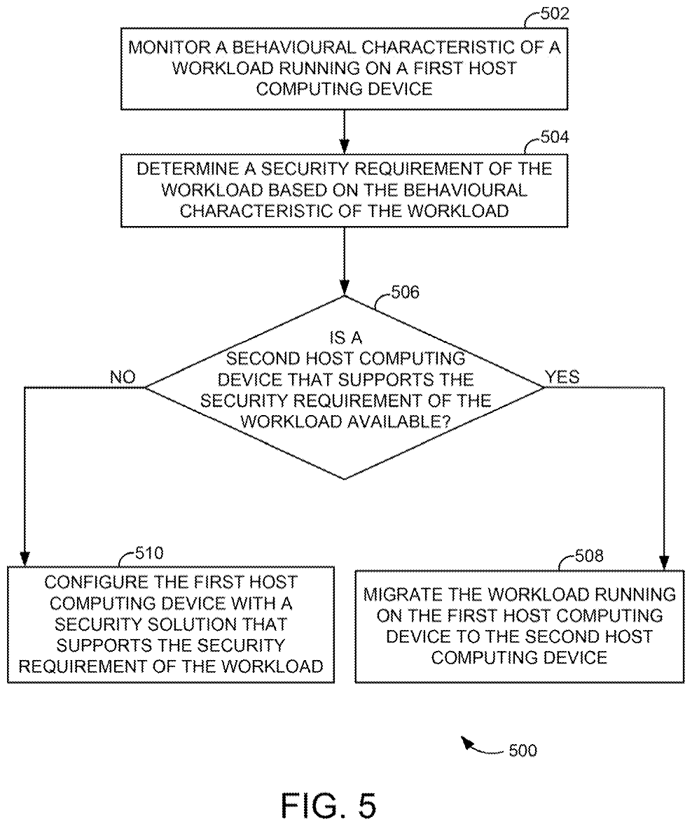

FIG. 5 is a flowchart illustrating an example method 500 for determining migration of a workload from a first host computing device to a second host computing device in a data center based on a security requirement. It should be understood that the process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, a behavioural characteristic of a workload running on a first host computing device in a data center may be monitored. At 504, a security requirement of the workload may be determined based on the behavioural characteristic of the workload. At 506, a check may be made to determine whether a second host computing device that supports the security requirement of the workload is available in the data center. When the second host computing device that supports the security requirement is available, the workload running on the first host computing device may be migrated to the second host computing device, at 508. When the second host computing device that supports the security requirement is not available, the first host computing device may be configured with a security solution that supports the security requirement of the workload, at 510.

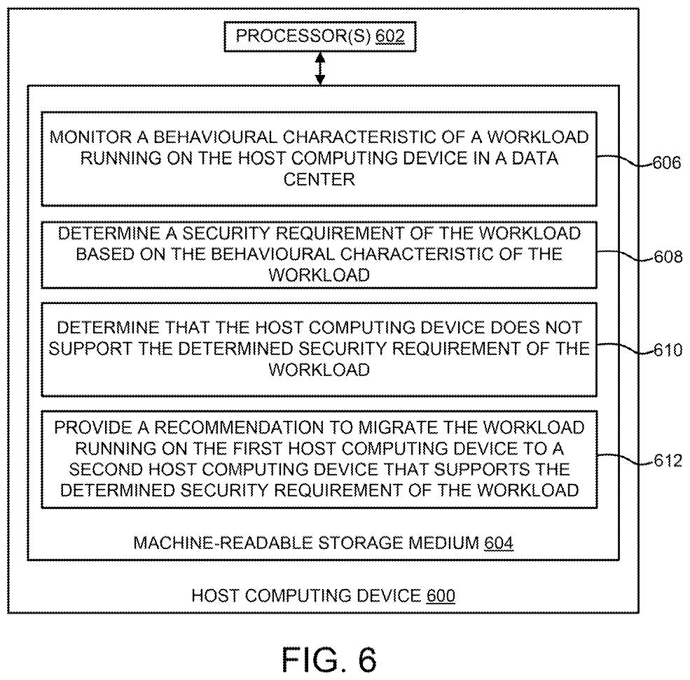

FIG. 6 is a block diagram of an example first host computing device 600 including non-transitory machine-readable storage medium storing instructions to provide a recommendation to migrate a workload running on first host computing device 600 to a second host computing device. First host computing device 600 may include a processor 602 and machine-readable storage medium 604 communicatively coupled through a system bus. Processor 602 may be any type of central processing unit (CPU), microprocessor, or processing logic that interprets and executes machine-readable instructions stored in machine-readable storage medium 604.

Machine-readable storage medium 604 may be a random-access memory (RAM) or another type of dynamic storage device that may store information and machine-readable instructions that may be executed by processor 602. For example, machine-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to first host computing device 600.

Machine-readable storage medium 604 may store instructions 606-612. In an example, instructions 606-612 may be executed by processor 602 to provide a recommendation to migrate a workload running on first host computing device 600 to a second host computing device. Example workload may include an application, a VM, a container, or the like. Instructions 606 may be executed by processor 602 to monitor a behavioural characteristic of a workload running on first host computing device 600 in a data center. In an example, instructions to monitor the behavioural characteristic of the workload may include instructions to monitor the characteristic of the workload based on a parameter selected from a group consisting of network flow information, input/output (I/O) activity information, and disaster recovery protection requirement.

Instructions 608 may be executed by processor 602 to determine a security requirement of the workload based on the behavioural characteristic of the workload. Instructions 610 may be executed by processor 602 to determine that first host computing device 600 does not support the determined security requirement of the workload. In an example, instructions to determine that first host computing device 600 does not support the determined security requirement of the workload may include instructions to:
obtain security policy information of the data center from the management node. Example security policy information may include mapping between a plurality of host computing devices and corresponding security solutions.
compare the behavioural characteristic of the workload with the security policy information of the data center.
determine that first host computing device 600 does not support the security requirement of the workload based on the comparison.

Instructions 612 may be executed by processor 602 to provide a recommendation to migrate the workload running on first host computing device 600 to a second host computing device that supports the determined security requirement of the workload. Further, machine-readable storage medium 604 may store instructions to enable to migrate the workload running on first host computing device 600 to the second host computing device in accordance with the recommendation.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
monitoring a behavioural characteristic of a workload running on a first host computing device in a data center;
determining a security requirement of the workload based on the behavioural characteristic of the workload;
determining a second host computing device that supports the security requirement of the workload; and
generating a recommendation to migrate the workload running on the first host computing device to the second host computing device in the data center.

2. The method of claim 1, further comprising:
migrating the workload running on the first host computing device to the second host computing device in accordance with the recommendation.

3. The method of claim 1, wherein monitoring the characteristic of the workload comprises:
monitoring the characteristic of the workload based on a parameter selected from a group consisting of network flow information, input/output (I/O) activity information, and disaster recovery protection requirement.

4. The method of claim 1, wherein determining the second host computing device that supports the security requirement of the workload comprises:
determining the second host computing device having a license for a security solution that supports the security requirement of the workload.

5. The method of claim 1, wherein the workload comprises an application, a virtual machine, or a container.

6. A method comprising:
monitoring a behavioural characteristic of a workload running on a host computing device in a data center;
determining a security requirement of the workload based on the behavioural characteristic of the workload;
determining that a security solution that supports the security requirement of the workload is not available in the data center; and
generating a recommendation to configure the host computing device with the security solution that supports the security requirement of the workload.

7. The method of claim 6, further comprising:
configuring the host computing device with the security solution that provides the security requirement in accordance with the recommendation.

8. The method of claim 6, wherein monitoring the behavioural characteristic of the workload comprises:
capturing inbound and/or outbound network flow associated with the workload running on the host computing device;
measuring network traffic of the workload running on the host computing device based on the inbound and/or outbound network flow; and
identifying the behavioural characteristic of the workload based on the measured network traffic.

9. The method of claim 6, wherein monitoring the behavioural characteristic of the workload comprises:
monitoring an input/output (I/O) activity performed by the workload; and
identifying the behavioural characteristic of the workload based on the monitored I/O activity.

10. The method of claim 6, wherein monitoring the behavioural characteristic of the workload comprises:
determining a type of an application running on the workload;
determining whether the workload requires disaster recovery protection from a protection site to a recovery site based on the type of application; and
identifying the behavioural characteristic of the workload based on the determination that the workload requires the disaster recovery protection.

11. The method of claim 6, wherein determining that the security solution that supports the security requirement of the workload is not available comprises:
comparing the security requirement of the workload with security policy information of the data center, wherein the security policy information comprises mapping between a plurality of host computing devices and corresponding security solutions; and
determining that the security solution that supports the security requirement of the workload is not available in the data center based on an outcome of the comparison.

12. A system comprising:
a management node; and
a host computing device in communication with the management node, the host computing device comprising:
an application host to execute an application, wherein the application host comprises:
an in-guest agent to identify a behavioural characteristic of the application running in the application host; and
a context module to:
determine a security requirement of the application based on the identified behavioural characteristic of the application; and
provide a recommendation, to the management node, to migrate the application or application host to another host computing device that supports the security requirement of the application.

13. The system of claim 12, wherein the management node comprises a resource scheduler to:
determine a second host computing device that supports the security requirement of the application; and
migrate the application or application host to the second host computing device in accordance with the recommendation.

14. The system of claim 12, wherein the context module is to:
obtain security policy information of the data center from the management node, the security policy information comprising mapping between a plurality of host computing devices and corresponding security solutions;
compare the behavioural characteristic of the application with the security policy information of the data center; and
provide the recommendation to migrate the application or application host based on the comparison.

15. The system of claim 12, wherein the context module is to:
capture inbound and/or outbound network flow associated with the application host running on the host computing device;
measure network traffic of the application host running on the host computing device based in the inbound and/or outbound network flow; and
identify the behavioural characteristic of the application based on the measured network traffic.

16. The system of claim 12, wherein the context module is to:
monitor an input/output (I/O) activity performed by the application host; and
identify the behavioural characteristic of the application based on the monitored I/O activity.

17. The system of claim 12, wherein the context module is to:
determine whether the application host requires disaster recovery protection from a protection site to a recovery site based on a type of the application; and
identify the behavioural characteristic of the application based on the determination that the application host requires disaster recovery protection.

18. The system of claim 12, wherein the application host comprises a virtual machine or a container.

19. A management node comprising:
a processing resource; and
a memory having a management application executable by the processing resource to:
obtain a security requirement of a workload running on a first host computing device in a data center;
determine whether a second host computing device that supports the security requirement of the workload is available in the data center;
when the second host computing device that supports the security requirement is not available, configure the first host computing device with a security solution that supports the security requirement of the workload; and
when the second host computing device that supports the security requirement is available, migrate the workload running on the first host computing device to the second host computing device that supports the security requirement of the application.

20. The management node of claim 19, wherein the security requirement of the workload is determined by the first host computing device, the first host computing device is to:
identify a characteristic of the workload based on a parameter selected from a group consisting of network flow information, input/output (I/O) activity information, and disaster recovery protection requirement; and
determine the security requirement of the workload based on the behavioural characteristic of the workload.

21. The management node of claim 19, wherein the management application is to:
determine whether the second host computing device having a license for the security solution that supports the security requirement of the workload is available in the data center.

22. A non-transitory machine-readable storage medium encoded with instructions that, when executed by a processor of a host computing device, cause the processor to:
monitor a behavioural characteristic of a workload running on the host computing device in a data center;
determine a security requirement of the workload based on the behavioural characteristic of the workload;
determine that the host computing device does not support the determined security requirement of the workload; and
provide a recommendation to migrate the workload running on the first host computing device to a second host computing device that supports the determined security requirement of the workload.

23. The non-transitory machine-readable storage medium of claim 22, further comprising instructions to:
enable to migrate the workload running on the first host computing device to the second host computing device in accordance with the recommendation.

24. The non-transitory machine-readable storage medium of claim 22, wherein instructions to monitor the behavioural characteristic of the workload comprise instructions to:
monitor the characteristic of the workload based on a parameter selected from a group consisting of network flow information, input/output (I/O) activity information, and disaster recovery protection requirement.

25. The non-transitory machine-readable storage medium of claim 22, wherein instructions to determine that the host computing device does not support the determined security requirement of the workload comprise instructions to:
obtain security policy information of the data center from the management node, the security policy information comprising mapping between a plurality of host computing devices and corresponding security solutions;
compare the behavioural characteristic of the workload with the security policy information of the data center; and
determine that the host computing device does not support the security requirement of the workload based on the comparison.

26. The non-transitory machine-readable storage medium of claim 22, wherein the workload comprises an application, a virtual machine, or a container.
